(19) United States
(12) Patent Application Publication
(10) Pub. No.: US 2024/0146546 A1
(43) Pub. Date: May 2, 2024

(54) MODULE AUTHENTICATION

(71) Applicant: Rambus Inc., San Jose, CA (US)

(72) Inventors: Scott C. BEST, Palo Alto, CA (US); Thomas VOGELSANG, Mountain View, CA (US); Michael Alexander HAMBURG, ‘s-Hertogenbosch (NL); Mark Evan MARSON, Carlsbad, CA (US); Helena HANDSCHUH, Miami, FL (US); HAMPEL E. Craig, Los Altos, CA (US); Kenneth Lee WRIGHT, Sunnyvale, CA (US)

(21) Appl. No.: 18/278,374

(22) PCT Filed: Feb. 25, 2022
(86) PCT No.: PCT/US22/17883

§ 371 Date: Aug. 22, 2023

Related U.S. Application Data
(60) Provisional application No. 63/169,531, filed on Apr. 1, 2021.
(60) Provisional application No. 63/156,280, filed on Mar. 3, 2021.

(51) Int. Cl. H04L 9/32; G06F 21/73

(52) U.S. Cl. CPC H04L 9/3268; G06F 21/73

(57) ABSTRACT

An asymmetric key cryptographic system is used to generate a cryptographic certificate for authenticating a memory module. This certificate is generated based on information, readable by the authenticator (e.g., host system), from at least one device on the memory module that is not read in order to obtain the certificate. For example, the certificate for authenticating a module may be stored in the nonvolatile memory of a serial presence detect device. The certificate itself, however, is based at least in part on information read from at least one other device on the memory module. Examples of this other device include a registering clock driver, DRAM device(s), and/or data buffer device(s). In an embodiment, the information read from a device (e.g., DRAM) may be based on one or more device fingerprint(s) derived from physical variations that occur naturally, and inevitably, during integrated circuit manufacturing.

### BRIEF DESCRIPTION OF THE DRAWINGS

FIG. 1 is a diagram illustrating a module authentication system.

FIGS. 2A-2B illustrate module authentication system using a registered clock driver.

FIGS. 3A-3B illustrate a module authentication system using dynamic random access memory (DRAM) device information.

FIG. 4 illustrates a module authentication system using data buffer device information.

FIG. 5 illustrates a module authentication system using information from multiple sources.

FIG. 6 is a flowchart illustrating a method of authenticating a module.

FIG. 7A illustrates programming a module for authentication by a host.

FIG. 7B illustrates a host authenticating a programmed module.

FIG. 8 is a flowchart illustrating a method of authenticating a programmed module.

FIG. 9 is a flowchart illustrating a method of programming a module.

FIG. 10 is a block diagram of a processing system.

### DETAILED DESCRIPTION OF THE EMBODIMENTS

Memory modules (e.g., dual inline memory modules—DEVIMs) may be sold and marketed using different classes that have different characteristics (e.g., slow, fast, low reliability, high reliability, desktop, server, etc.) and accordingly different pricing. This creates an incentive for malevolent actors to “relabel” a lower classed and lower priced module (e.g., slow) as a higher classed module (e.g., fast) and then selling the lower classed module at the higher classed price.

In an embodiment, an asymmetric key cryptographic system is used to generate a cryptographic certificate for authenticating a memory module. This certificate is generated based on information, readable by the authenticator (e.g., host system), from at least one device on the memory module that is not read in order to obtain the certificate. For example, the certificate for authenticating a module may be stored in the nonvolatile memory of a serial presence detect (a.k.a., SPD) chip. The certificate itself, however, is based at least in part on information read from at least one other device on the memory module. Examples of this other device include: a registering clock driver (a.k.a., an RCD chip), DRAM device(s), and/or data buffer device(s). In an embodiment, the information read from a device (e.g., DRAM) may be based on one or more device fingerprint(s) derived from physical variations that occur naturally, and inevitably, during integrated circuit manufacturing.

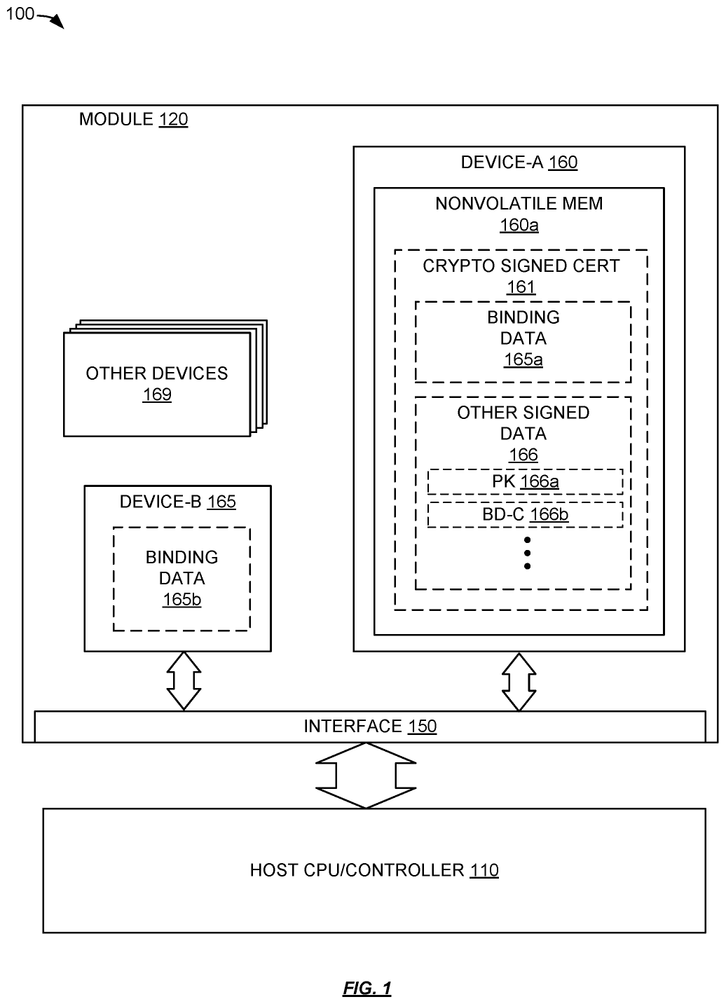

FIG. 1 is a diagram illustrating a module authentication system. In FIG. 1, system 100 comprises host CPU/controller (host) 110 and module 120. Module 120 includes interface 150, device-A 160, device-B 165, and other devices 169. Host 110 is operatively coupled to module 120 via interface 150. Device-A 160 and Device-B 165 are operatively coupled to interface 150. Thus, host 110 may access device-A 160 and device-B 165 via interface 150. Other devices 169 on module 120 may also be operatively coupled to interface 150, and therefore be accessible by host 110 via interface 150.

Host 110, device-A 160, device-B 165, and other devices 169 may be or comprise integrated circuit type devices, such as are commonly referred to as a “chips”. The controller functionality of a memory controller (such as the controller functionality of host 110) manages the flow of data going to and from memory devices and/or memory modules. A memory controller can be a separate, standalone chip, or integrated into another chip. For example, a memory controller may be included on a single die with a microprocessor, or included as part of a more complex integrated circuit system such as a block of a system on a chip (SOC).

In an embodiment, device-A 160, device-B 165, and other devices 169 may be or comprise one or more of a dynamic random access memory device, a command-address buffer device (e.g., a registered clock driver—RCD), a data buffer device, and/or a serial presence detect (SPD) device. In one or more embodiments, module 120 may be, but is not limited to, a dual inline memory module (DIMM) such as a DDR4, DDR5 etc. DIMM, a load reduced DIMM (LRDIMM), a registered DIMM (RDIMM), a fully buffered DIMM (FB-DIMM), or an unbuffered DIMM (UDIMM).

Device-A 160 includes nonvolatile memory 160a. Nonvolatile memory 160a is readable by host 110 via interface 150. Nonvolatile memory 160a stores data including at least a cryptographically signed certificate 161. Cryptographically signed certificate 161 may employ asymmetric cryptography. Cryptographically signed certificate 161 certifies the authenticity of module 120 when there is a match between a signed copy of binding data 165a and binding data 165b read directly from device-B. Other signed data 166 may include, but is not limited to, a public key 166a (e.g., the public key of a private-public key pair where the private key was used to generate cryptographically signed certificate 161, and where the public key is either available via a public key infrastructure, or can be otherwise validated by a second certificate), other device binding data 166b, and other data to be verified by cryptographically signed certificate 161.

To determine whether module 120 is authentic, host 110 reads cryptographically signed certificate 161 and using a cryptographic signature verification process, verifies that binding data 165a has not been altered. Host 110 also accesses device-B 165 to extract binding data 165b directly from device-B 165. If binding data 165a from cryptographically signed certificate 161 matches binding data 165b that was read directly from device-B 165, host 110 determines that module 120 is authentic. If binding data 165a from cryptographically signed certificate 161 does not match binding data 165b that was read directly from device-B 165, host 110 determines that module 120 is counterfeit or has otherwise been altered and should not be trusted. In an embodiment, device-B 165 is more difficult to “clone”, design, and/or manufacture than device-A 160. Thus, although cryptographically signed certificate 161 is stored in the easier device to clone (device-A 160), a counterfeiter would need to clone/reproduce both the easier device (device-A 160) and the more difficult device to clone (device-B 165) in order for module 120 to be authenticated by host 110.

Device-B 165 may be, for example, a registering clock driver (RCD) device and binding data 165b may be, or be based on, a device identification number read from the registering clock driver (RCD) device. Device-B 165 may be, for example, a data buffer device and binding data 165b may be, or be based on, a device identification number read from the data buffer device. Device-B 165 may be, for example, a DRAM device and binding data 165b may be, or be based on, a device identification number read from the DRAM device. Device-B 165 may be, for example, a DRAM device and binding data 165b may be, or be based on, configuration information/bits read from the DRAM device. Device-B 165 may be, for example, a DRAM device and binding data 165b may be, or be based on, repair map information/bits read from the DRAM device. Device-B 165 may be, for example, a DRAM device and binding data 165b may be, or be based on, a device “fingerprint”.

An example of a device fingerprint is a map of weak/strong bits in the refresh/repair sense. For example, known data could be written into the DRAM device and then refresh operations delayed until at least some bits lose their stored values. A map of the locations of the bits that lost their values may serve as a device fingerprint. Since this map arises from physical variations that occur naturally, and inevitably, during integrated circuit manufacturing, this type of map would be difficult to clone. This type of map may be considered a type of physically unclonable function (PUF). However, because the bits that lose their values is dependent upon factors such as supply voltage and circuit temperature, the bits of the map may be combined algorithmically using, for example, error correction and/or a locality sensitive hashing.

It should be understood that various combinations of the aforementioned binding data examples may be used as the basis for binding data 165a. Likewise, various combinations of binding data from different integrated circuits (e.g., other devices 169) may be used. These combinations may be used as is, sorted, and/or hashed via a digest function (e.g., SHA-1, SHA-2, SHA-3, etc.) to generate the binding data 165a stored in the certificate. Host 110 may then reconstruct binding data 165b using the same combinations, sorting, hashing, etc. in order to authenticate module 120.

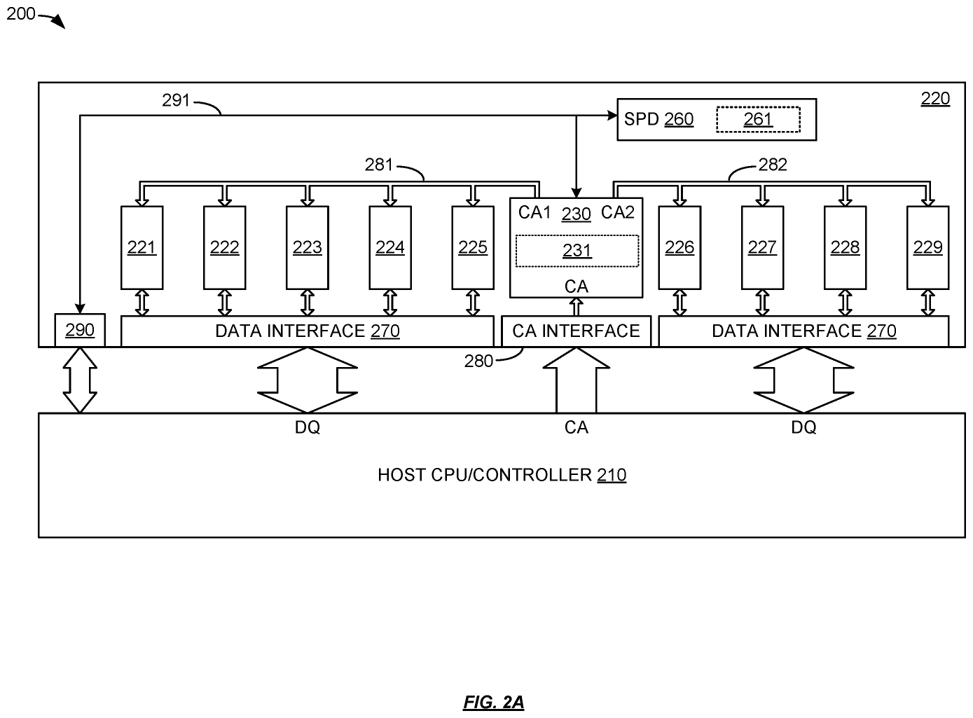

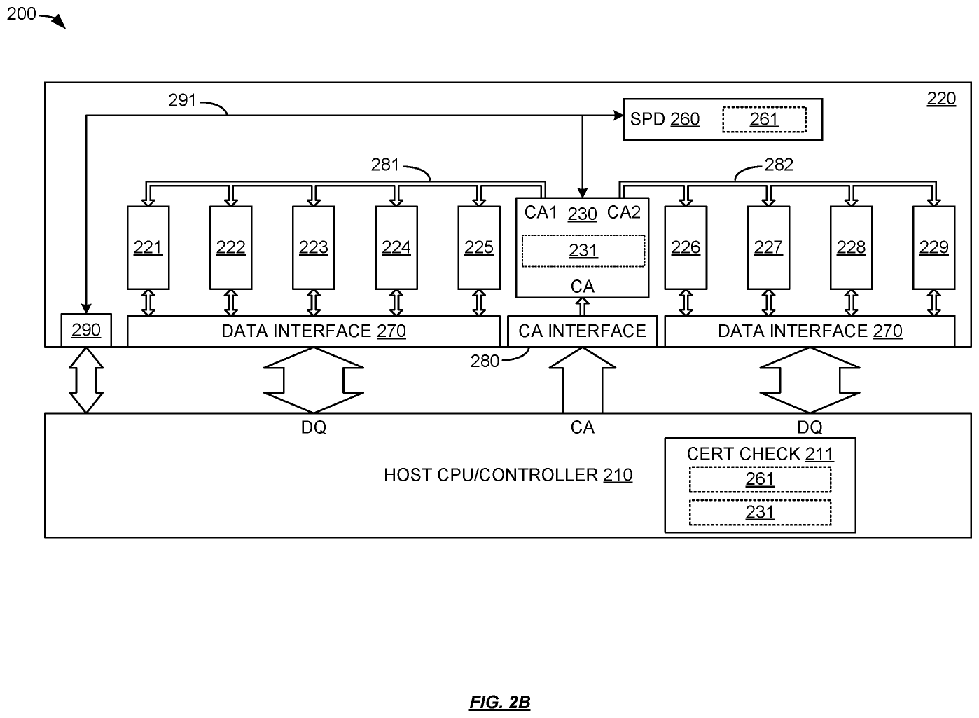

FIGS. 2A-2B illustrate a module authentication system. In FIGS. 2A-2B, system 200 comprises host CPU/controller (host) 210 and module 220. Host 210 is operatively coupled to module 220 via data signals (DQ), command-address signals (CA), and serial presence detect signals. Module 220 includes memory components 221-229, buffer device 230, serial presence detect device (SPD) 260, data interface 270, command-address interface 280, and side-channel interface 290. Command-address interface 280 is operatively coupled to buffer device 230. Buffer device 230 includes buffer device information 231. In an embodiment, buffer device information 231 may be, comprise, and/or be derived from, a device identification number stored within its nonvolatile memory. Buffer device 230 is operatively coupled to memory components 221-225 via secondary command-address signals CA1 281 (also referred to as CA bus 281). Buffer device 230 is operatively coupled to memory components 226-229 via secondary command-address signals CA2 282 (also referred to as CA bus 282). Buffer device 230 may also be referred to as a command/address (CA) Register. Thus, module 220 may be considered to be a registered module, or Registered Dual Inline Memory Module (R-DIMM).

Side-channel interface 290 is operatively coupled to SPD 260 and buffer device 230 via side-channel signals 291. SPD 260 includes cryptographically signed certificate 261 within its nonvolatile memory. Side-channel interface 290 and side-channel signals 291 may implement or conform to a serial channel communication protocol or specification. For example, side-channel interface 290 and side-channel signals 291 may be, or comprise, one or more signals that conform to a serial presence detect (SPD) bus, I2C bus, and/or I3C bus.

Host 210, memory components 221-229, buffer device 230, and SPD 260 may be or comprise integrated circuit type devices, such as are commonly referred to as “chips”. The controller functionality of a memory controller (such as the controller functionality of host 210) manages the flow of data going to and from memory devices and/or memory modules. Memory components 221-229 may be standalone devices, or may include multiple memory integrated circuit dies—such as components of a multi-chip module. A memory controller can be a separate, standalone chip, or integrated into another chip. For example, a memory controller may be included on a single die with a microprocessor, or included as part of a more complex integrated circuit system such as a block of a system on a chip (SOC).

Buffer device 230 is operatively coupled to CA interface 280 and memory components 221-229 to help isolate the electrical loading of the on-module DRAM memory components 221-229 from the command-address channel coupled to host 210. Without buffer device 230, the aggregate load of memory components 221-229 would degrade the achievable signaling rate of the command-address channel and hence the overall bandwidth performance of the memory subsystem. In an embodiment, all command-address traffic sent between host 210 and memory components 221-229 is first received by buffer device 230 via CA interface 280 (also referred to as CA bus 280).

In FIGS. 2A-2B, a single CA interface 280 and two sets of secondary CA signals 281-282 are illustrated. It should be understood however, that in some embodiments, buffer device 230 may receive independent CA signals over two respective independent CA interfaces. These sets of independent CA signals may be received, for example, on opposite sides of module 220. In another example, these sets of independent CA signals may be time or otherwise multiplexed with each other on the same set of signal traces. Buffer device 230 may receive each of the two sets of independent CA signals and drive each of the two sets of CA signals, respectively, to two secondary CA signal sets (i.e., two channels from a host to 4 CA channels, where each DRAM channel includes a set of 4 or 5 DRAMs—two DRAM channels on the right and two DRAM channels on the left.)

In an embodiment, host 210 (and certificate check process 211, in particular) may use cryptographically signed certificate 261 and buffer device information 231 to determine whether module 220 is genuine or counterfeit (i.e., where it is an “authentic” module 220.) This is illustrated in FIG. 2B. To determine whether module 220 is authentic, host 210 obtains the cryptographically signed certificate 261 from SPD 260 and using a cryptographic signature verification process, verifies that the protected data (i.e., the buffer device information) within the cryptographically signed certificate 261 has not been altered. Host 210 also accesses buffer device 230 to extract buffer device information 231 directly from buffer device 230. If buffer device information from cryptographically signed certificate 261 matches buffer device information 231 that was read directly from buffer device 230, host 210 determines that module 220 is authentic. If buffer device information contained within the cryptographically signed certificate 261 does not match buffer device information 231 that was read directly from buffer device 230, host 210 determines that module 220 is counterfeit or has otherwise been modified and should not be trusted.

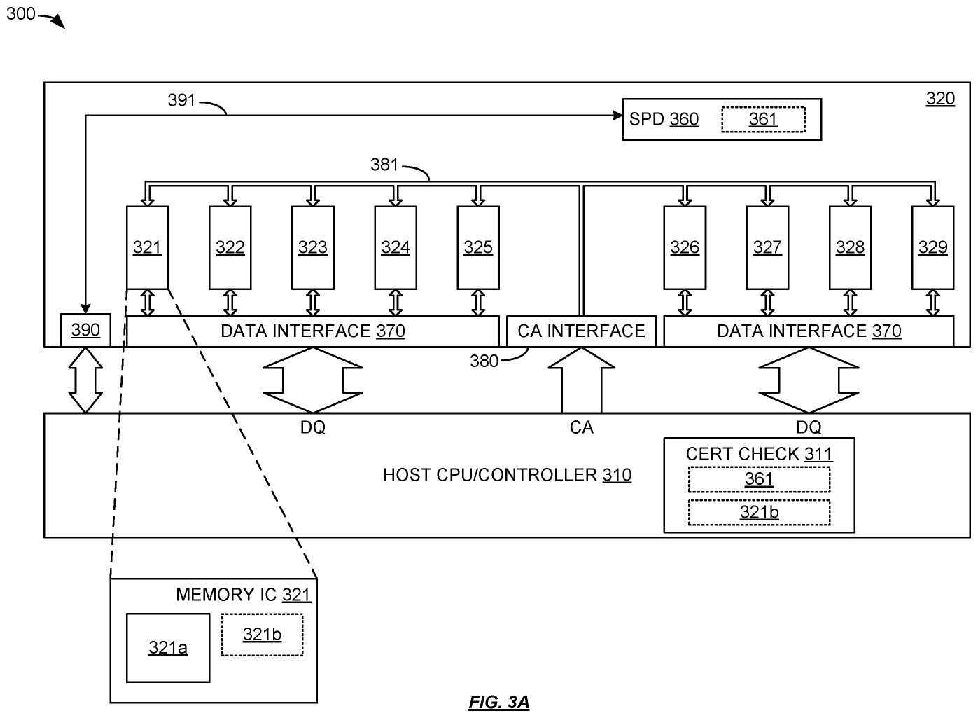

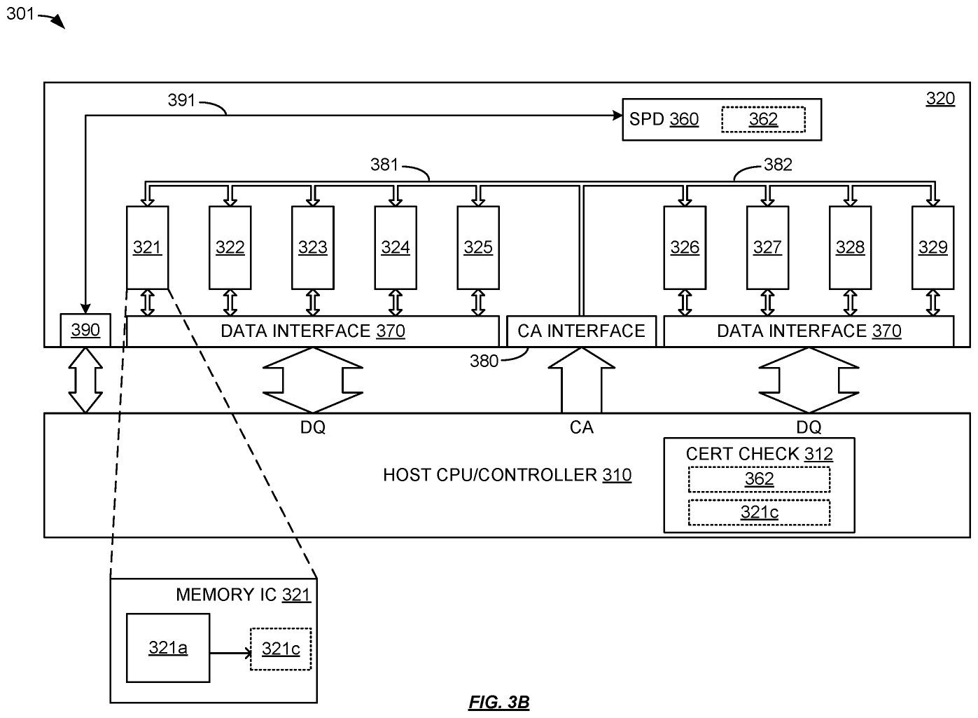

FIGS. 3A-3B illustrate a module authentication system using dynamic random access memory (DRAM) device information. In particular, FIG. 3A illustrates a module authentication system that is based on information read from at least one DRAM device. FIG. 3B illustrates a module authentication system that is based on a device fingerprint derived from physical variations that occur naturally, and inevitably, during integrated circuit manufacturing.

In FIGS. 3A-3B, system 300 and system 301 comprises host CPU/controller (host) 310 and module 320. Host 310 is operatively coupled to module 320 via data signals (DQ), command-address signals (CA), and serial presence detect signals. Module 320 includes memory components 321-329, serial presence detect device (SPD) 360, data interface 370, command-address interface 380, and side-channel interface 390. Memory components 321-329 may be DRAM devices. Command-address interface 380 is operatively coupled to memory components 321-329 via CA bus 381. In FIG. 3A, memory device 321 includes memory array 321a and memory device information 321b. In FIG. 3B, memory device 321 includes memory array 321a and fingerprint information 321c that is derived from memory array 321a. In an embodiment, memory device information 321b may be, comprise, and/or be derived from, a device identification number stored in the device's nonvolatile memory, repair map information, and/or configuration information. Fingerprint information 321c may be, comprise, and/or be derived from a map of weak/strong bits in the refresh/repair sense. For example, known data could be written into one or more memory components 321-329 and then refresh operations delayed until at least some bits lose their stored values. A map of the locations of the bits that lost their values may serve as a device fingerprint. Since this map arises from physical variations that occur naturally, and inevitably, during integrated circuit manufacturing, this type of map would be difficult to clone. This type of map may be considered a type of physically unclonable function (PUF). However, because the bits that lose their values are dependent upon factors such as supply voltage and circuit temperature, the bits of the map may be combined algorithmically using, for example, error correction and/or a locality sensitive hashing.

Side-channel interface 390 is operatively coupled to SPD 360 via side-channel signals 391. In FIG. 3A, SPD 360 includes cryptographically signed certificate 361 in nonvolatile memory. In FIG. 3B, SPD 360 includes cryptographically signed certificate 362 in nonvolatile memory. Side-channel interface 390 and side-channel signals 391 may implement or conform to a serial channel communication protocol or specification. For example, side-channel interface 390 and side-channel signals 391 may be, or comprise, one or more signals that conform to a serial presence detect (SPD) bus, I2C bus, and/or I3C bus.

Host 310, memory components 321-329, and SPD 360 may be or comprise integrated circuit type devices, such as are commonly referred to as “chips”. The controller functionality of a memory controller (such as the controller functionality of host 310) manages the flow of data going to and from memory devices and/or memory modules. Memory components 321-329 may be standalone devices, or may include multiple memory integrated circuit dies—such as components of a multi-chip module. A memory controller can be a separate, standalone chip, or integrated into another chip. For example, a memory controller may be included on a single die with a microprocessor, or included as part of a more complex integrated circuit system such as a block of a system on a chip (SOC).

In an embodiment, as illustrated in FIG. 3A, host 310 (and certificate check process 311, in particular) may use cryptographically signed certificate 361 and memory device information 321b to determine whether module 320 is genuine or counterfeit (i.e., whether it is an “authentic” module 320.) In another embodiment, as illustrated in FIG. 3B, host 310 (and certificate check process 312, in particular) may use cryptographically signed certificate 362 and fingerprint information 321c to determine whether module 320 is genuine or counterfeit. The process for using information from a device on a module and a cryptographically signed certificate from an SPD device (i.e., cryptographically signed certificate 361 and/or cryptographically signed certificate 362) to authenticate the module has been described herein with reference to at least FIGS. 1, 2A, and 2B. Thus, for the sake of brevity, this process will not be re-described here.

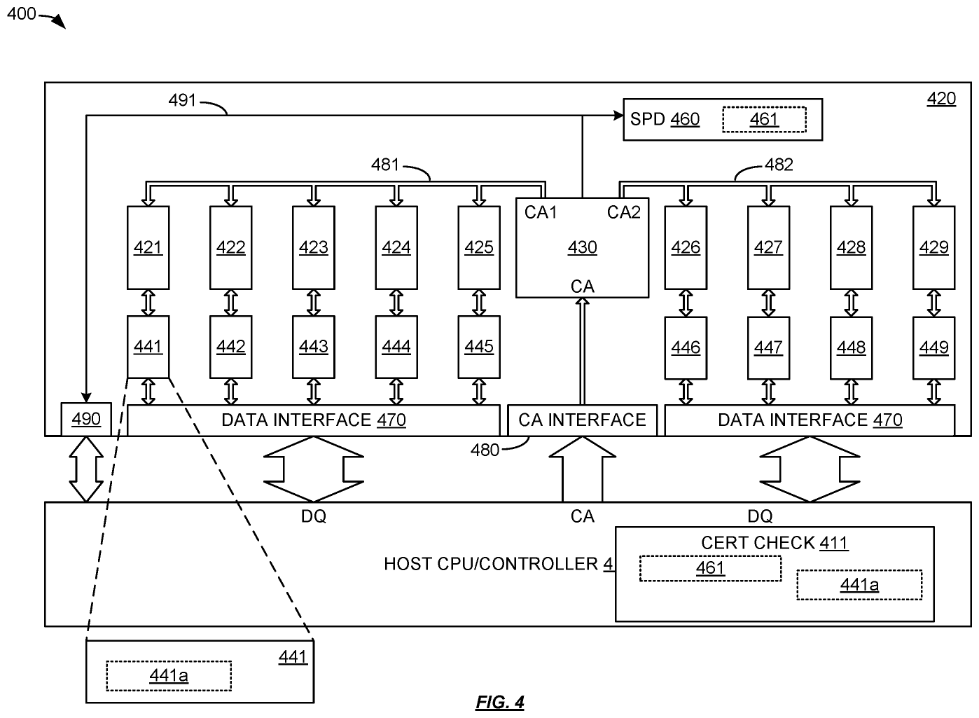

FIG. 4 illustrates a module authentication system using data buffer device information. In FIG. 4, system 400 comprises host CPU/controller (host) 410 and module 420. Host 410 is operatively coupled to module 420 via data signals (DQ), command-address signals (CA), and serial presence detect signals. Module 420 includes memory components 421-429, buffer device 230, data buffer devices 441-449, SPD 460, data interface 470, command-address interface 480, and side-channel interface 490. Command-address interface 480 is operatively coupled to buffer device 230. Data buffer devices 441-449 are operatively coupled to data interface 470. Data buffer devices 441-449 are also operatively coupled to memory components 421-429, respectively. Data buffer device 441 includes data buffer device information 441a. In an embodiment, data buffer device information 441a may be, comprise, and/or be derived from, a device identification number stored in nonvolatile memory.

Buffer 430 is operatively coupled to memory components 421-425 via secondary command-address signals CA1 481 (also referred to as CA bus 481). Buffer 430 is operatively coupled to memory components 426-429 via secondary command-address signals CA2 482 (also referred to as CA bus 482).

Side-channel interface 490 is operatively coupled to serial presence detect device (SPD) 460 and buffer 430 via side-channel signals 491. SPD 460 includes cryptographically signed certificate 461 in nonvolatile memory. Side-channel interface 490 and side-channel signals 491 may implement or conform to a serial channel communication protocol or specification. For example, side-channel interface 490 and side-channel signals 491 may be, or comprise, one or more signals that conform to a serial presence detect (SPD) bus, I2C bus, and/or I3C bus.

Host 410, memory components 421-429, buffer 430, data buffer devices 441-449, and SPD 460 may be or comprise integrated circuit type devices, such as are commonly referred to as “chips”. The controller functionality of a memory controller (such as the controller functionality of host 410) manages the flow of data going to and from memory devices and/or memory modules. Memory components 421-429 may be standalone devices, or may include multiple memory integrated circuit dies—such as components of a multi-chip module. A memory controller can be a separate, standalone chip, or integrated into another chip. For example, a memory controller may be included on a single die with a microprocessor, or included as part of a more complex integrated circuit system such as a block of a system on a chip (SOC).

Buffer 430 is operatively coupled to CA interface 480 and memory components 421-429 to help isolate the electrical loading of the on-module DRAM memory components 421-429 from the command-address channel coupled to host 410. Without buffer 430, the aggregate load of memory components 421-429 would degrade the achievable signaling rate of the command-address channel and hence the overall bandwidth performance of the memory subsystem. In an embodiment, all command-address traffic sent between host 410 and memory components 421-429 is first received by buffer 430 via CA interface 480 (also referred to as CA bus 480).

Data buffer devices 441-449 are operatively coupled to data interface 470 and memory components 421-429, respectively, to help isolate the electrical loading of the on-module DRAM memory components 421-429 from the data channel coupled to host 410. Without data buffer devices 441-449, the aggregate load of memory components 421-429 may degrade the achievable signaling rate of the data channel and hence the overall bandwidth performance of the memory subsystem. In an embodiment, all data traffic sent between host 410 and memory components 421-429 is first received by a respective data buffer device 441-449 via data interface 470 (also referred to as DQ bus 470). Since both data and command-address signals are buffered, module 420 may be considered to be a load reduced module, or Load Reduced Dual Inline Memory Module (LR-DIMM).

In an embodiment, host 210 (and certificate check process 411, in particular) may use cryptographically signed certificate 461 and data buffer device information 441a to determine whether module 420 is genuine or counterfeit (i.e., whether it is an “authentic” module 420.) The process for using information from a device on a module and a cryptographically signed certificate from an SPD device (i.e., cryptographically signed certificate 461) to authenticate the module has been described herein with reference to at least FIGS. 1, 2A, and 2B. Thus, for the sake of brevity, this process will not be re-described here.

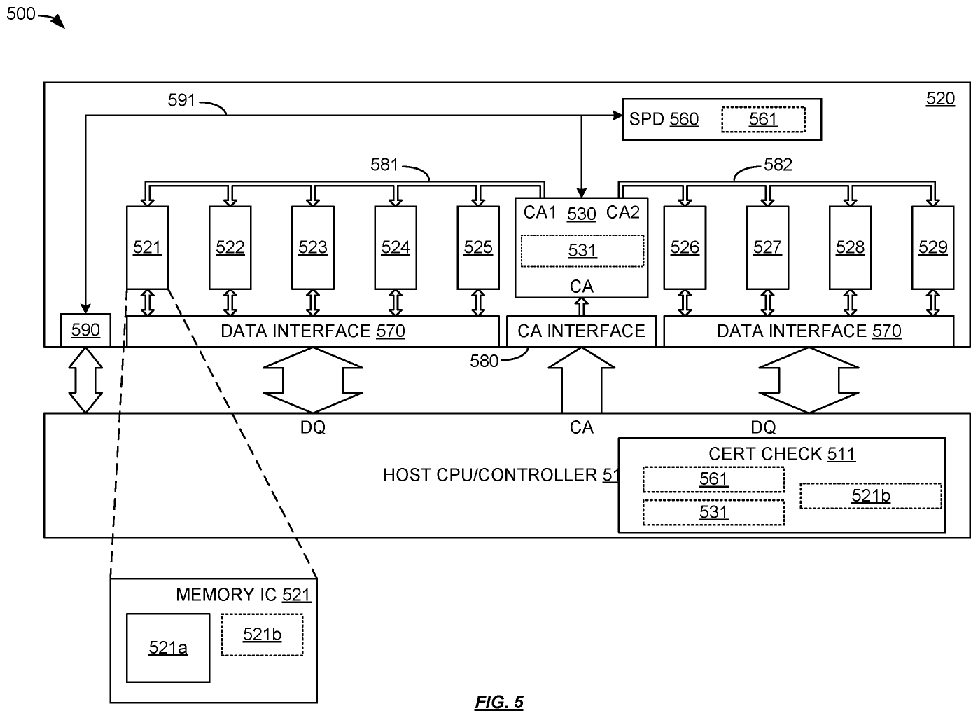

FIG. 5 illustrates a module authentication system using information from multiple sources. In FIG. 5, system 500 comprises host CPU/controller (host) 510 and module 520. Host 510 is operatively coupled to module 520 via data signals (DQ), command-address signals (CA), and serial presence detect signals. Module 520 includes memory components 521-529, serial presence detect device (SPD) 560, data interface 570, command-address interface 580, and side-channel interface 590. Command-address interface 580 is operatively coupled to memory components 521-529 via CA bus 581. Buffer 530 includes buffer device information 531. Memory device 521 includes memory array 521a and memory device information 521b. In an embodiment, memory device information 521b may be, comprise, and/or be derived from, a device identification number stored in nonvolatile memory, repair map information, and/or configuration information.

Side-channel interface 590 is operatively coupled to SPD 560 via side-channel signals 591. SPD 560 includes cryptographically signed certificate 561 in nonvolatile memory. Side-channel interface 590 and side-channel signals 591 may implement or conform to a serial channel communication protocol or specification. For example, side-channel interface 590 and side-channel signals 591 may be, or comprise, one or more signals that conform to a serial presence detect (SPD) bus, I2C bus, and/or I3C bus.

In an embodiment, host 510 (and certificate check process 511, in particular) may use cryptographically signed certificate 561, buffer device information 531, and memory device information 521b to determine whether module 520 is genuine or counterfeit (i.e., whether it is an “authentic” module 520.) The process for using information from multiple devices on a module and a cryptographically signed certificate from an SPD device (i.e., cryptographically signed certificate 561) to authenticate the module is similar to the processes that have been described herein with reference to at least FIGS. 1, 2A, and 2B. Thus, for the sake of brevity, this process will not be re-described here, except that the binding data that is collected from the multiple sources should be combined or aggregated in the same way that the data was combined/aggregated when the certificate was created. For example, in an embodiment, the buffer device information 531 and memory device information 521b may be numerically sorted and then processed by a digest function (e.g., SHA-2), both during the certificate creation process and during the module verification process. In other embodiments, the binding data may be simply aggregated without further sorting or digest processing.

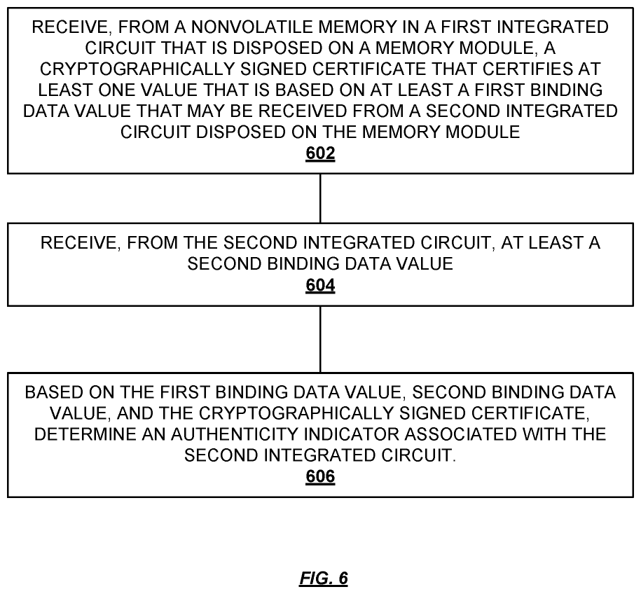

FIG. 6 is a flowchart illustrating a method of authenticating a module. One or more steps illustrated in FIG. 6 may be performed by, for example, system 100, system 200, system 300, system 301, system 400, system 500, and/or their components. From a nonvolatile memory in a first integrated circuit that is disposed on a memory module, a cryptographically signed certificate is received that certifies at least one value that is based on at least a first binding data value that may be received from a second integrated circuit disposed on the memory module (602). For example, host 110 may receive, from device-A 160 cryptographically signed certificate 161 that was stored in nonvolatile memory 160a where cryptographically signed certificate 161 certifies at least binding data 165a.

From the second integrated circuit, at least a second binding data value is received (604). For example, a value from binding data 165b may be read from device-B 165 by host 110. Based on the first binding data value, second binding data value, and the cryptographically signed certificate, an authenticity indicator associated with the second integrated circuit is determined (606). For example, to determine whether module 120 is authentic, host 110 may read cryptographically signed certificate 161 and, using a cryptographic signature verification process, verify that binding data 165a has not been altered. If binding data 165a has been altered, module 120 is not authenticated. Host 110 also accesses device-B 165 to extract binding data 165b directly from device-B 165. If binding data 165a from cryptographically signed certificate 161 matches binding data 165b that was read directly from device-B 165 (and verified), host 110 determines that module 120 is authentic. If binding data 165a from cryptographically signed certificate 161 does not match binding data 165b that was read directly from device-B 165, host 110 determines that module 120 is counterfeit or has otherwise been modified and should not be trusted.

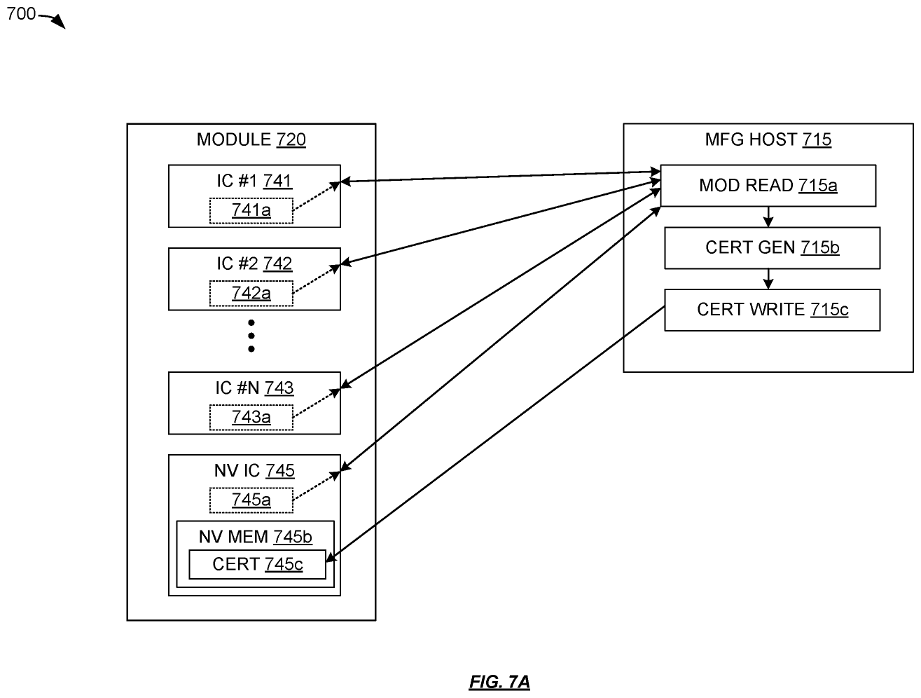

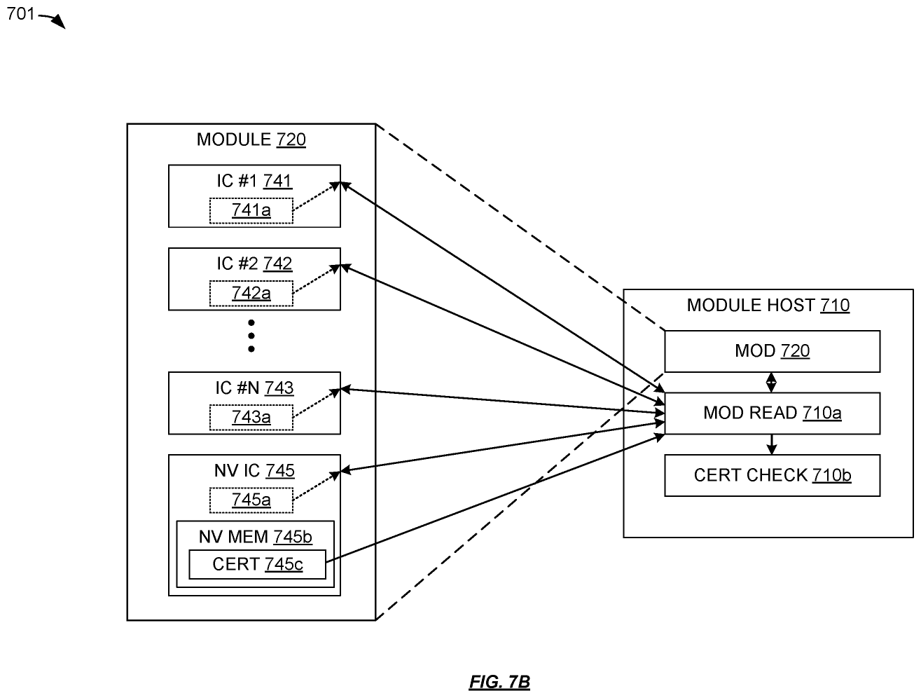

FIG. 7A illustrates programming a module for authentication by a host. In FIG. 7A, system 700 comprises manufacturing host 715 and module 720. Module 720 includes integrated circuits #1 to N 741-743 (where N is an arbitrary positive integer), and programmable nonvolatile integrated circuit 745. Integrated circuits #1 to N 741-743 and nonvolatile integrated circuit 745 may include respective binding data 741a-743a, and 745a that can be read by manufacturing host 715. Manufacturing host 715 reads binding data 741a-743a from at least one of integrated circuits #1 to N 741-743 (715a). Based on the binding data 741a-743a from at least one of integrated circuits #1 to N 741-743, manufacturing host 715 generates a cryptographically signed certificate (715b). In an embodiment, the manufacturer uses the private half of an asymmetric signing key pair (not shown) to generate the certificate. Manufacturing host 715 then writes the cryptographically signed certificate 745c to nonvolatile memory 745b of nonvolatile integrated circuit 745. In an embodiment, the public half of the asymmetric signing key pair (not shown) is included within the certificate (where the public key is either available via a public key infrastructure, or can be otherwise validated by a second certificate) and then used during the verification process. Module 720 may then be installed in, and authenticated by, a host system.

FIG. 7B illustrates a host authenticating a programmed module. In FIG. 7B, module host 710 includes module 720. Module host 710 reads binding data 741a-743a from at least one of integrated circuits #1 to N 741-743 and reads cryptographically signed certificate 745c from nonvolatile memory 745b of nonvolatile integrated circuit 745 (710a). Based on the binding data 741a-743a from at least one of integrated circuits #1 to N 741-743, and cryptographically signed certificate 745c from nonvolatile memory 745b, module host 710 determines whether module 720 is authentic or counterfeit (710b).

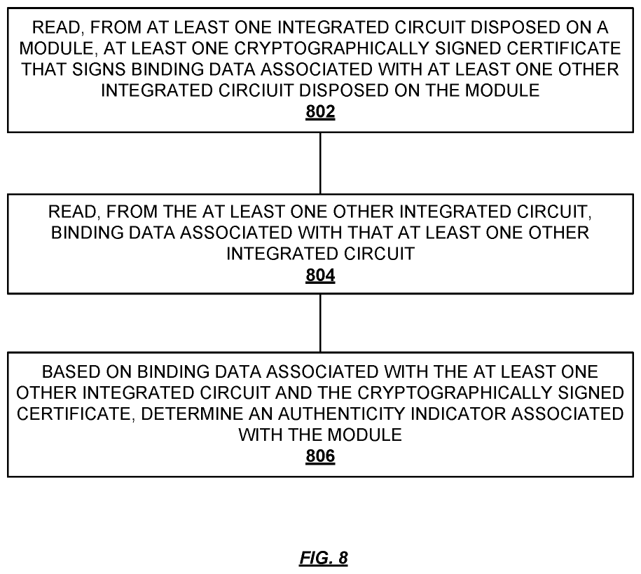

FIG. 8 is a flowchart illustrating a method of authenticating a module. One or more steps illustrated in FIG. 8 may be performed by, for example, system 100, system 200, system 300, system 301, system 400, system 500, and/or their components. From at least one integrated circuit disposed on a module, at least one cryptographically signed certificate is read that contains a signed copy of binding data associated with at least one other integrated circuit on the module (802). For example, host 110 may read, from device-A 160, cryptographically signed certificate 161 that contains a signed copy of binding data 165b on device-B 165.

From the at least one other integrated circuit, binding data associated with that at least one other integrated circuit is read (804). For example, host 110 may read, from device-B 165, binding data 165b. Based on binding data associated with the at least one other integrated circuit and the cryptographically signed certificate, an authenticity indicator associated with the module is determined (806). For example, based on the validity of cryptographically signed certificate 161, the values signed therein, and the binding data 165b read from device-B 165, host 110 may determine whether module 120 is authentic or counterfeit.

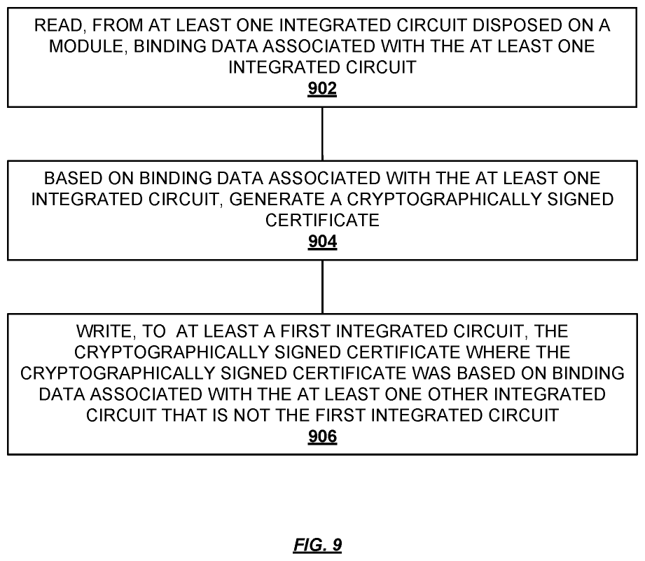

FIG. 9 is a flowchart illustrating a method of programming a module. One or more steps illustrated in FIG. 9 may be performed by, for example, system 700, and/or its components. From at least one integrated circuit disposed on a module, binding data associated with the at least one integrated circuit is read (902). For example, manufacturing host 715 may read, from module 720, binding data 741a from integrated circuit #1 741.

Based on binding data associated with the at least one integrated circuit, a cryptographically signed certificate is generated (904). For example, manufacturing host 715 may, using a private half of an asymmetric public-private key pair, generate a cryptographically signed certificate 745c based on binding data 741a from integrated circuit #1 741. To at least a first integrated circuit, the cryptographically signed certificate is written where the cryptographically signed certificate was based on binding data associated with the at least one other integrated circuit that is not the first integrated circuit (906). For example, manufacturing host 715 may write cryptographically signed certificate 745c, which was based on binding data from integrated circuit #1 741, to nonvolatile integrated circuit 745.

The methods, systems and devices described above may be implemented in computer systems, or stored by computer systems. The methods described above may also be stored on a non-transitory computer readable medium. Devices, circuits, and systems described herein may be implemented using computer-aided design tools available in the art, and embodied by computer-readable files containing software descriptions of such circuits. This includes, but is not limited to one or more elements of system 100, system 200, system 300, system 301, system 400, system 500, and/or system 700, and their components. These software descriptions may be: behavioral, register transfer, logic component, transistor, and layout geometry-level descriptions. Moreover, the software descriptions may be stored on storage media or communicated by carrier waves.

Data formats in which such descriptions may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email. Note that physical files may be implemented on machine-readable media such as: 4 mm magnetic tape, 8 mm magnetic tape, 3½ inch floppy media, CDs, DVDs, and so on.

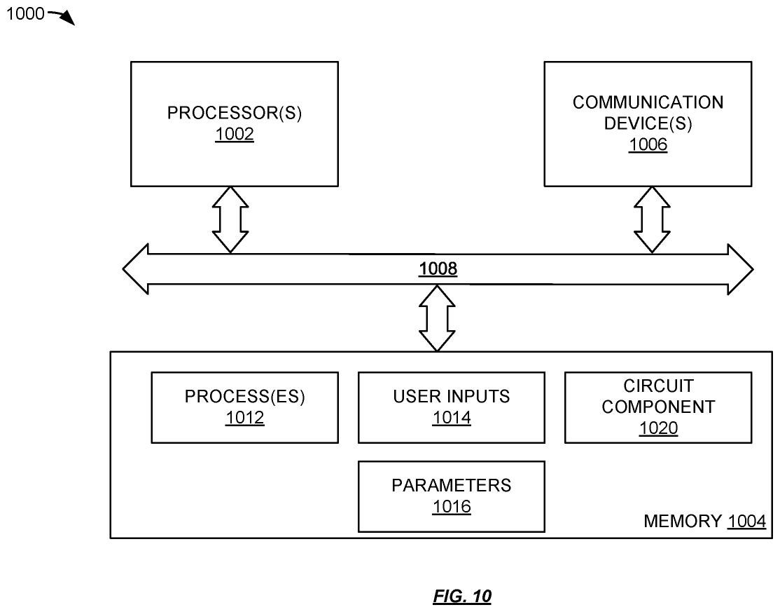

FIG. 10 is a block diagram illustrating one embodiment of a processing system 1000 for including, processing, or generating, a representation of a circuit component 1020. Processing system 1000 includes one or more processors 1002, a memory 1004, and one or more communications devices 1006. Processors 1002, memory 1004, and communications devices 1006 communicate using any suitable type, number, and/or configuration of wired and/or wireless connections 1008.

Processors 1002 execute instructions of one or more processes 1012 stored in a memory 1004 to process and/or generate circuit component 1020 responsive to user inputs 1014 and parameters 1016. Processes 1012 may be any suitable electronic design automation (EDA) tool or portion thereof used to design, simulate, analyze, and/or verify electronic circuitry and/or generate photomasks for electronic circuitry. Representation 1020 includes data that describes all or portions of system 100, system 200, system 300, system 301, system 400, system 500, and/or system 700, and their components, as shown in the Figures.

Representation 1020 may include one or more of behavioral, register transfer, logic component, transistor, and layout geometry-level descriptions. Moreover, representation 1020 may be stored on storage media or communicated by carrier waves.

Data formats in which representation 1020 may be implemented include, but are not limited to: formats supporting behavioral languages like C, formats supporting register transfer level (RTL) languages like Verilog and VHDL, formats supporting geometry description languages (such as GDSII, GDSIII, GDSIV, CIF, and MEBES), and other suitable formats and languages. Moreover, data transfers of such files on machine-readable media may be done electronically over the diverse media on the Internet or, for example, via email.

User inputs 1014 may comprise input parameters from a keyboard, mouse, voice recognition interface, microphone and speakers, graphical display, touch screen, or other type of user interface device. This user interface may be distributed among multiple interface devices. Parameters 1016 may include specifications and/or characteristics that are input to help define representation 1020. For example, parameters 1016 may include information that defines device types (e.g., NFET, PFET, etc.), topology (e.g., block diagrams, circuit descriptions, schematics, etc.), and/or device descriptions (e.g., device properties, device dimensions, power supply voltages, simulation temperatures, simulation models, etc.).

Memory 1004 includes any suitable type, number, and/or configuration of non-transitory computer-readable storage media that stores processes 1012, user inputs 1014, parameters 1016, and circuit component 1020.

Communications devices 1006 include any suitable type, number, and/or configuration of wired and/or wireless devices that transmit information from processing system 1000 to another processing or storage system (not shown) and/or receive information from another processing or storage system (not shown). For example, communications devices 1006 may transmit circuit component 1020 to another system. Communications devices 1006 may receive processes 1012, user inputs 1014, parameters 1016, and/or circuit component 1020 and cause processes 1012, user inputs 1014, parameters 1016, and/or circuit component 1020 to be stored in memory 1004.

Implementations discussed herein include, but are not limited to, the following examples:

Example 1: A memory module, comprising: a plurality of dynamic random access memory (DRAM) devices; and, a first integrated circuit including nonvolatile memory to store a cryptographically signed certificate that includes at least one value that is based on at least a first binding data value physically originating from within a second integrated circuit on the memory module.

Example 2: The memory module of example 1, wherein the second integrated circuit is one of a plurality of DRAM devices.

Example 3: The memory module of example 1, wherein the second integrated circuit is a registered clock driver (RCD) integrated circuit device.

Example 4: The memory module of example 1, wherein the second integrated circuit is a data buffer integrated circuit.

Example 5: The memory module of example 1, wherein the cryptographically signed certificate is stored in the first integrated circuit during a manufacturing process of the memory module.

Example 6: The memory module of example 1, wherein the cryptographically signed certificate is further based on a second binding data value physically originating from within a third integrated circuit on the memory module.

Example 7: The memory module of example 6, wherein the cryptographically signed certificate is based on a digest function based on the first binding data value and the second binding data value.

Example 8: A memory module, comprising: a substrate having a memory module form factor; a serial presence detect (SPD) device, disposed on the substrate, having nonvolatile memory to store a cryptographically signed certificate that certifies at least one value that is based on at least a first binding data value to be received from a second integrated circuit disposed on the substrate; and a plurality of dynamic random access memory (DRAM) devices disposed on the substrate.

Example 9: The memory module of example 8, wherein the first binding data value is received from a first DRAM device of the plurality of DRAM devices.

Example 10: The memory module of example 9, wherein the first binding data value is based on configuration information that is to be received from the first DRAM device.

Example 11: The memory module of example 9, wherein the first binding data value is based on repair map information received from the first DRAM device.

Example 12: The memory module of example 9, wherein the first binding data value is based on a device fingerprint derived from physical variations that occur naturally, and inevitably, during integrated circuit manufacturing.

Example 13: The memory module of example 8, wherein the cryptographically signed certificate that certifies at least a second value that is based on at least a second binding data value to be received from a third integrated circuit disposed on the substrate.

Example 14: The memory module of example 13, wherein the second binding data value is a device identification value and the third integrated circuit is a register clock driver device.

Example 15: A method of authenticating a memory module, comprising: receiving, from a nonvolatile memory in a first integrated circuit that is disposed on the memory module, a cryptographically signed certificate that certifies at least one value that is based on at least a first binding data value that may be received from a second integrated circuit disposed on the memory module; receiving, from the second integrated circuit, at least a second binding data value; and, based on the first binding data value, second binding data value, and the cryptographically signed certificate, determine an authenticity indicator associated with the second integrated circuit.

Example 16: The method of example 15, wherein the authenticity indicator is associated with the second integrated circuit being authentic.

Example 17: The method of example 15, wherein the authenticity indicator is associated with at least one of the first integrated circuit and the second integrated circuit being counterfeit.

Example 18: The method of example 15, wherein the second integrated circuit is a registered clock driver.

Example 19: The method of example 18, wherein the second binding data value includes device identification information.

Example 20: The method of example 15, wherein the second integrated circuit is a dynamic random access memory (DRAM) device.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A memory module, comprising:
a plurality of dynamic random access memory (DRAM) devices; and,
a first integrated circuit including nonvolatile memory to store a cryptographically signed certificate that includes at least one value that is based on at least a first binding data value physically originating from within a second integrated circuit on the memory module.

2. The memory module of claim 1, wherein the second integrated circuit is one of a plurality of DRAM devices.

3. The memory module of claim 1, wherein the second integrated circuit is a registered clock driver (RCD) integrated circuit device.

4. The memory module of claim 1, wherein the second integrated circuit is a data buffer integrated circuit.

5. The memory module of claim 1, wherein the cryptographically signed certificate is stored in the first integrated circuit during a manufacturing process of the memory module.

6. The memory module of claim 1, wherein the cryptographically signed certificate is further based on a second binding data value physically originating from within a third integrated circuit on the memory module.

7. The memory module of claim 6, wherein the cryptographically signed certificate is based on a digest function based on the first binding data value and the second binding data value.

8. A memory module, comprising:
a substrate having a memory module form factor;
a serial presence detect (SPD) device, disposed on the substrate, having nonvolatile memory to store a cryptographically signed certificate that certifies at least one value that is based on at least a first binding data value to be received from a second integrated circuit disposed on the substrate; and,
a plurality of dynamic random access memory (DRAM) devices disposed on the substrate.

9. The memory module of claim 8, wherein the first binding data value is received from a first DRAM device of the plurality of DRAM devices.

10. The memory module of claim 9, wherein the first binding data value is based on configuration information that is to be received from the first DRAM device.

11. The memory module of claim 9, wherein the first binding data value is based on repair map information received from the first DRAM device.

12. The memory module of claim 9, wherein the first binding data value is based on a device fingerprint derived from physical variations that occur naturally, and inevitably, during integrated circuit manufacturing.

13. The memory module of claim 8, wherein the cryptographically signed certificate that certifies at least a second value that is based on at least a second binding data value to be received from a third integrated circuit disposed on the substrate.

14. The memory module of claim 13, wherein the second binding data value is a device identification value and the third integrated circuit is a register clock driver device.

15. A method of authenticating a memory module, comprising:
receiving, from a nonvolatile memory in a first integrated circuit that is disposed on the memory module, a cryptographically signed certificate that certifies at least one value that is based on at least a first binding data value that may be received from a second integrated circuit disposed on the memory module;
receiving, from the second integrated circuit, at least a second binding data value; and,
based on the first binding data value, second binding data value, and the cryptographically signed certificate, determine an authenticity indicator associated with the second integrated circuit.

16. The method of claim 15, wherein the authenticity indicator is associated with the second integrated circuit being authentic.

17. The method of claim 15, wherein the authenticity indicator is associated with at least one of the first integrated circuit and the second integrated circuit being counterfeit.

18. The method of claim 15, wherein the second integrated circuit is a registered clock driver.

19. The method of claim 18, wherein the second binding data value includes device identification information.

20. The method of claim 15, wherein the second integrated circuit is a dynamic random access memory (DRAM) device.
